(19) United States
(12) Patent Application Publication
(10) Pub. No.: US 2015/0090673 A1
(43) Pub. Date: Apr. 2, 2015

(54) APPARATUS AND METHOD FOR PURIFYING LIQUID

(71) Applicant: KONINKLIJKE PHILPS N.V., EINDHOVEN (NL)

(72) Inventors: Haihui Wu, Eindhoven (NL); Weiran Wang, Eindhoven (NL); Gang Wang, Eindhoven (NL)

(73) Assignee: KONINKLIJKE PHILIPS N.V., EINDHOVEN (NL)

(21) Appl. No.: 14/387,253

(22) PCT Filed: Mar. 26, 2013
(86) PCT No.: PCT/IB2013/052411

§ 371 Date: Sep. 23, 2014

(30) Foreign Application Priority Data
Mar. 31, 2012 (CN) PCT/CN2012/073398

(51) Int. Cl. B01D 71/02; B01D 65/02; B01D 61/12; B01D 61/02; B01D 61/08

(52) U.S. Cl. CPC B01D 71/02; B01D 61/027; B01D 61/08; B01D 61/12; B01D 65/02; B01D 2311/14; B01D 2311/103; B01D 2321/08
USPC 210/774; 210/181; 210/106; 210/120

(57) ABSTRACT

The invention relates to an apparatus and a method for purifying liquid. The apparatus comprises an air-tight container (301) and a heater (305). The air-tight container is configured to store the liquid, wherein at least a portion of the container consists of a filter membrane (303). The heater is configured to heat the liquid such that the liquid is driven out of the container through the filter membrane. The heater can actively increase the pressure in the container by heating the liquid and/or gas in the container. Sometimes, a portion of the liquid stored in the air-tight container may be vaporized, which increases the pressure in the container as well. Under the increased pressure, the liquid can be easily driven out of the container while being purified via the filter membrane. Since the filtration is actively driven by heating, the filtration efficiency of the apparatus can be controlled and improved according to various applications.

### FIELD OF THE INVENTION

The invention generally relates to liquid purification technology, and more particularly relates to an apparatus and a method for purifying liquid.

### BACKGROUND OF THE INVENTION

There are many processes to treat liquids used for consumption, such as washing, drinking or other purposes. Among these processes, filtration processes that utilize a filter to remove contaminants, such as particles, bacteria, ions, etc., from the liquid is frequently employed. However, for most of the filtration processes, the filtration is substantially passively driven by, e.g., the gravity of the liquid, which is not effective enough in various purification applications.

### SUMMARY OF THE INVENTION

It would, therefore, be advantageous to provide an apparatus and a method for purifying liquid, such as water or water solutions, etc., with higher efficiency.

According to an embodiment of the invention, an apparatus for purifying liquid comprises: an air-tight container for storing the liquid, wherein at least a portion of the container consists of a filter membrane; and a heater for heating the liquid such that the liquid is driven out of the container through the filter membrane.

In some embodiments of the invention, the heater can actively increase the pressure in the container by heating the liquid and/or gas in the container. Sometimes, a portion of the liquid stored in the air-tight container may be vaporized, which increases the pressure in the container as well. Under the increased pressure, the liquid can be easily driven out of the container as well as purified via the filter membrane. Since the filtration is actively driven by heating, the filtration efficiency can be controlled and improved according to various applications.

In an embodiment, the filter membrane comprises a nano-filtration membrane. The nano-filtration membrane can selectively allow some monovalent ions that do not affect the human body to pass and bar almost all multivalent ions, low-molecular-weight organic substances, and organic contaminants such as bacteria.

In an embodiment, the nano-filtration membrane comprises a ceramic nano-filtration membrane. The ceramic nano-filtration membrane can withstand temperatures in excess of 100 degrees centigrade, which extends the useful life(?) of the apparatus.

In an embodiment, the filter membrane is disposed above the heater such that at least a portion of the bubbles released from the heater during the boiling of the liquid flush along the filter membrane. When the liquid within the container is heated to the boil, the released bubbles can flush the filter membrane and clean the filtration pores of the filter membrane. In this way, the filter membrane can be self-cleaning, and its lifetime can be extended.

In an embodiment, the apparatus further comprises a chamber for collecting the liquid driven out of the container, wherein the chamber is at least partially separated from the container via the filter membrane. The chamber facilitates the collecting of the liquid purified by the apparatus.

In an embodiment, the apparatus further comprises: a sensor for measuring the liquid level in the container; and a controller for controlling the heating by the heater according to the measurement from the sensor. This control mechanism can prevent the apparatus from over-heating, thereby reducing safety risks of using the apparatus.

In an embodiment, the apparatus further comprises a relief valve in fluid communication with the container, which is configured to maintain the pressure in the container below a predetermined pressure. The relief valve improves the safety of the apparatus.

In an embodiment, there is provided a kettle comprising the apparatus for purifying liquid of any one of the previous embodiments. The apparatus for purifying liquid within the kettle can effectively remove solid particles, organic contaminants, and metal ions from water.

Moreover, as boiled water is produced as well as purified in the kettle, no additional heating is needed after the purification. Thus, the kettle reduces a second pollution risk of the boiled water.

In an embodiment, there is provided a method of purifying liquid, which comprises: storing liquid in an air-tight container, wherein at least a portion of the container consists of a filter membrane; increasing the pressure in the container by heating the liquid such that the liquid is driven out of the container through the filter membrane.

Detailed explanations and other aspects of the invention will be given below.

### BRIEF DESCRIPTION OF THE DRAWINGS

Particular aspects of the invention will now be explained with reference to the embodiments described hereinafter and considered in connection with the accompanying drawings, in which identical parts or sub-steps are designated in the same manner:

FIG. 1 depicts an apparatus 100 for purifying liquid according to an embodiment of the invention;

FIG. 2 depicts an apparatus 200 for purifying liquid according to another embodiment of the invention;

FIG. 3 depicts a kettle 300 according to an embodiment of the invention;

FIG. 4 depicts a flowchart of a method 400 for purifying liquid according to an embodiment of the invention.

### DETAILED DESCRIPTION OF THE INVENTION

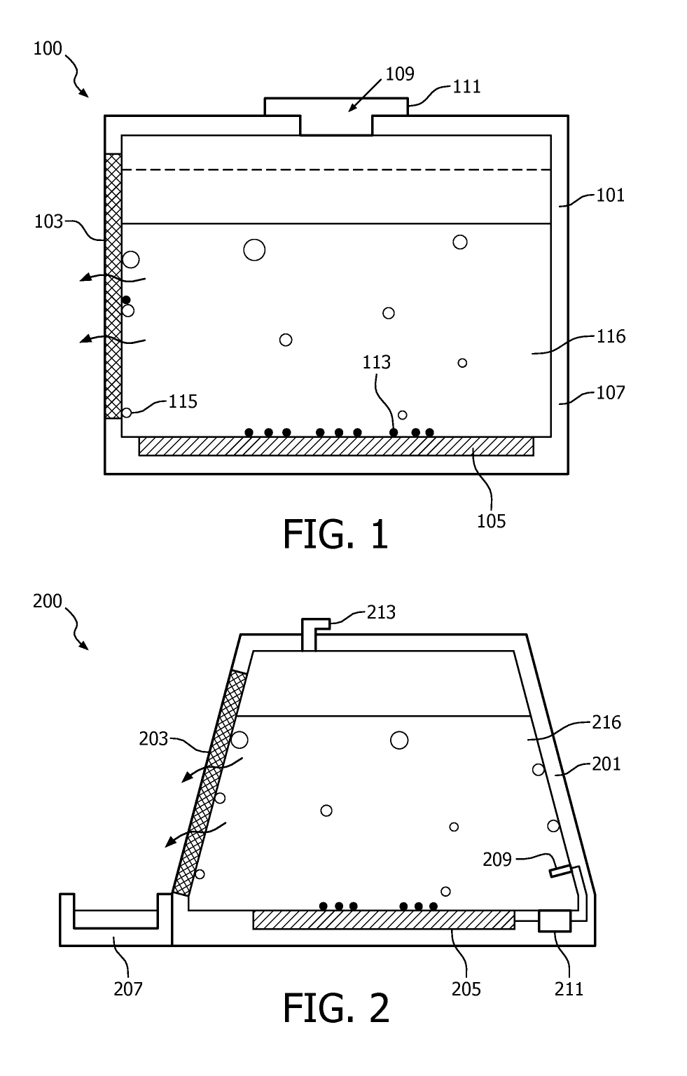

FIG. 1 depicts an apparatus 100 for purifying liquid according to an embodiment of the invention. The apparatus 100 may be used to purify water, solutions, suspensions or other suitable liquids, by removing solid particles, organic contaminants, and metal ions therefrom.

As depicted in FIG. 1, the apparatus 100 comprises:
an air-tight container 101 for storing the liquid 116, wherein at least a portion of the container 101 consists of a filter membrane 103; and
a heater 105 for heating the liquid 116 such that the liquid 116 is driven out of the container 101 through the filter membrane 103.

In the embodiment illustrated in FIG. 1, the container 101 comprises a housing 107 defining a space for storing the liquid 116. A portion of the housing 107 consists of the filter membrane 103. In some other embodiments, all of the housing 107 may consist of the filter membrane 103. The housing 107 may be made of plastics, metal, glass, ceramics or other suitable materials. In an embodiment, the filter membrane 103 may be removable from the housing 107 to enable regular maintenance or replacement of the filter membrane 103. Alternatively, the filter membrane 103 may be formed integrally with the housing 107. The housing 107 comprises an opening 109, which is disposed on, for example, the top side or lateral side of the housing 107. The opening 109 is configured for pouring the liquid 116 to be purified into the container 101, and sometimes, for pouring the remaining liquid 116 out of the container 101, e.g., after a large portion of the liquid 116 has been purified by the apparatus 100. In the embodiment, the apparatus 100 further comprises a cover 111, which is at least partially removable from the housing 107. The cover 111 may be attached to the housing 107, for example, via a fastener (not shown), or threaded into the opening 109 so as to avoid detachment from the housing 107 under the influence of high pressure in the container 101. The cover 111 has an outline matching the opening 109. The cover 111 may comprise a sealing ring or a sheath of silicon rubber, which can be used to prevent the liquid 116 from leaking through the opening 109. The thus-configured container 101 is air-tight. In other words, the housing 107 can maintain the liquid 116 in the container 101 unless the pressure in the container 101 exceeds a pressure threshold.

The filter membrane 103 has filtration pores that permit the liquid 116 to flow out of the container 101 when the pressure in the container 101 exceeds the pressure threshold. In some embodiments, the filter membrane 103 comprises a nano-filtration membrane. The nano-filtration membrane is a pressure-driven membrane, and has pore sizes ranging from 0.1 nm to 10 nm. In some embodiments, deviation of the pore size is allowed. For example, nano-filtration membranes having pore sizes ranging from 0.05 nm to 50 nm still work. In an example, the filter membrane 103 may comprise a ceramic nano-filtration membrane. The ceramic nano-filtration membrane can withstand temperatures over 100 degrees centigrade. In another example, the nano-filtration membrane may be a polymer membrane. When the apparatus 100 is used to purify raw water or tap water, the nano-filtration membrane can selectively allow some monovalent ions that do not affect the human body to pass and bar almost all multivalent ions, low-molecular-weight organic substances, and organic contaminants such as bacteria. In some other embodiments, the filter membrane 103 may comprise a microfiltration membrane, an ultra-filtration membrane or a reverse osmosis membrane that has different pore sizes than the nano-filtration membrane.

In an embodiment, the pressure threshold that permits the liquid 116 to flow out substantially depends on the pore size of the filtration pores and the size of the liquid molecule(s). Generally, for the filter membrane 103 with smaller pores, a higher pressure in the container 101 is required to drive the liquid 116 out. Likewise, for the liquid with bigger molecules, a higher pressure is required. For example, when the apparatus 100 is used to purify water, a pressure ranging from 200 kPa to 5 MPa may be required to drive the water out. For other liquids such as ethanol or isopropyl alcohol, a higher pressure may be required, since molecules of these liquids are bigger than H2O molecules.

As depicted in FIG. 1, the heater 105 is disposed on the bottom side of the container 101. For example, the heater 105 is an electrical heating device. In some other embodiments, the heater 105 may be a burner disposed under the container 101, and the burner is configured to heat the liquid 116 in the container 101 via the bottom of the housing 107. The position of the heater 105 can also be variable. For example, the heater 105 may be disposed on the lateral side of the container 101, or suspended from the top side of the housing 107 via a rod (not shown).

In operation, the heater 105 actively heats the liquid 116 in the container 101 so as to increase the temperature in the container 101. The increased temperature of the container 101 causes the liquid 116 and/or the gas in the container 101 to expand, thereby increasing the pressure in the container 101. The gas may be air that occupies some of the space in the container 101 when the liquid 116 is poured in (?), or it may be vaporized from the liquid 116 in the container 101 during the heating. Further, the container 101 is air-tight except for a fluid passage provided by filtration pores of the filter membrane 103. In this way, the pressure in the container 101 may exceed the pressure threshold under heating conditions and then drive the liquid 116 out of the container 101 through the filter membrane 103. In some embodiments, the heater 105 may heat the liquid 116 to the boil such that at least a portion of the liquid 116 in the air-tight container 101 may be vaporized. The vaporization of the liquid 116 continuously increases the pressure in the container 101 till the pressure reaches or exceeds the pressure threshold required for the liquid molecules to pass the filter membrane 103. Thus, the liquid 116 can be continuously driven out of the container 101 through the filter membrane 103. Driving the liquid 116 out of the container 100 tends to decrease the pressure in the container 100, which is however compensated by more and more vapour being generated by heating. Moreover, when the liquid 116 passes through the filter membrane 103, contaminants 113 in the liquid 116 such as solid particles, multivalent ions, organic contaminants or any other suitable undesirable (?) materials that are too big to get through the filter membrane 103 are kept in the container 101 by the filter membrane 103. For example, some of the contaminants 113 may be kept in the remaining liquid 116, and some other contaminants 113 may stick to the filter membrane 103 and are brushed into the remaining liquid 116 again at a later point in time. In this way, the purity of the liquid 116 driven out of the container 101 is improved by filtration. Further, the increased temperature of the liquid 116 in the container 101 can cause at least partial decomposition of some of the organic contaminants in the liquid 116, which further improves the purity of the liquid. Moreover, since the filtration is actively driven by heating performed by the heater 105, the filtration efficiency can be adjusted according to different applications, for example, by adjusting the temperature of the liquid and/or the gas in the container 101.

In the embodiment illustrated in FIG. 1, the filter membrane 103 is disposed above the heater 105. In operation, when the liquid 116 is heated to the boil by the heater 105, the liquid 116 in the container 101 is heavily vaporized. The vaporization of the liquid 116 introduces bubbles 115 into the liquid 116, which rise from the heater 105 up to the topside of the container 101.

As the filter membrane 103 is disposed above the heater 105, some of the bubbles 115 released from the heater 105 during the boiling of the liquid 116 will flush along the filter membrane 103. The contaminants 113 stick to the filter membrane 103, such as those blocking the filtration pores of the filter membrane 103, and can be flushed away from the filter membrane 103. In this way, the filter membrane 103 can be self-cleaning during the purification, and the lifetime of the apparatus 100 can be significantly extended. In an alternative embodiment, the filter membrane 103 can be disposed such that only a part thereof is above the heater 105.

FIG. 2 depicts an apparatus 200 for purifying liquid according to another embodiment of the invention. As depicted in FIG. 2, the apparatus 200 comprises:
an air-tight container 201 for storing the liquid 216, wherein at least a portion of the container 201 consists of a filter membrane 203; and
a heater 205 for heating the liquid 216 such that the liquid 216 is driven out of the container 201 through the filter membrane 203.

In the embodiment illustrated in FIG. 2, the heater 205 is disposed on the bottom side of the container 201. The filter membrane 203 is disposed above the heater 205, and on one lateral side of the container 201. And the lateral side of the container 201 slopes at an acute angle from the bottom side of the container 201. In operation, when the liquid 216 is heated to the boil and bubbles rise from the heater 205, the oblique filter membrane 203 can easily contact more bubbles as it exposes a wider area to the heater 205. Therefore, the filter membrane 203 can be more effectively cleaned by the bubbles released from the heater 205. It can be understood by those skilled in this art that the structures of the container and the filter membrane depicted in FIGS. 1 and 2 are illustrative or exemplary and not restrictive; other suitable structures can also be employed according to different applications. Moreover, the position of the heater can also be variable. For example, the heater may be disposed on the lateral side of the container, or suspended from the top side of the container via a rod.

In the embodiment, the apparatus 200 further comprises a chamber 207 for collecting the liquid driven out of the container 201. The chamber 207 is disposed outside the container 201, and at least partially separated from the container 201 via the filter membrane 201. In some embodiments, the chamber 207 may be removable from the container 201. For example, the chamber 207 may be attached to the container 201 by fasteners. In some other embodiments, the chamber 207 may be integrated into the container 201, for example, integrally formed by a molding process.

The apparatus 200 further comprises safety control modules for reducing safety risks. For example, the apparatus 200 comprises a sensor 209 for measuring the liquid level in the container 201, and a controller 211 for controlling the heating by the heater 205 according to the measurement from the sensor 209. In detail, the sensor 209 is disposed inside the container 201, for example, fixed in a specific position on the lateral side of the container 201 and a few millimeters above the bottom side of the container 201. The sensor 209 is electrically coupled to the controller 211. And the controller 211 is electrically coupled to the heater 205. In operation, when the liquid level in the container 201 is below the sensor 209 or a specific area sensed by the sensor 209, the sensor 209 may send a warning signal to the controller 211 to inform about the liquid level. In response to the warning signal, the controller 211 may provide a control signal for powering off the heater 205 to the heater 205. Accordingly, the heater 205 may be powered off so as to avoid heating of the remaining liquid 216 in the container 201.

In some embodiments, the apparatus 200 may further comprise a relief valve 213, which is configured to maintain the pressure in the container 201 below a predetermined pressure. The predetermined pressure should be higher than a pressure threshold, permitting the liquid 216 to flow out of the container 201. For example, the predetermined pressure relates to the compressive strength of the material and the structure of the container 201. The relief valve 213 is in fluid communication with the container 201. For example, the relief valve 213 may be a spring-type relief valve, a poppet-type relief valve or other suitable types of relief valves. When the pressure in the container 201 exceeds the predetermined pressure, the relief valve 213 may automatically turn on and leak liquid 216 or gas in the container 201 therefrom. Therefore, the relief valve 213 can reduce damage risk caused by high pressure in the container 201, which significantly improves the safety of the apparatus 200.

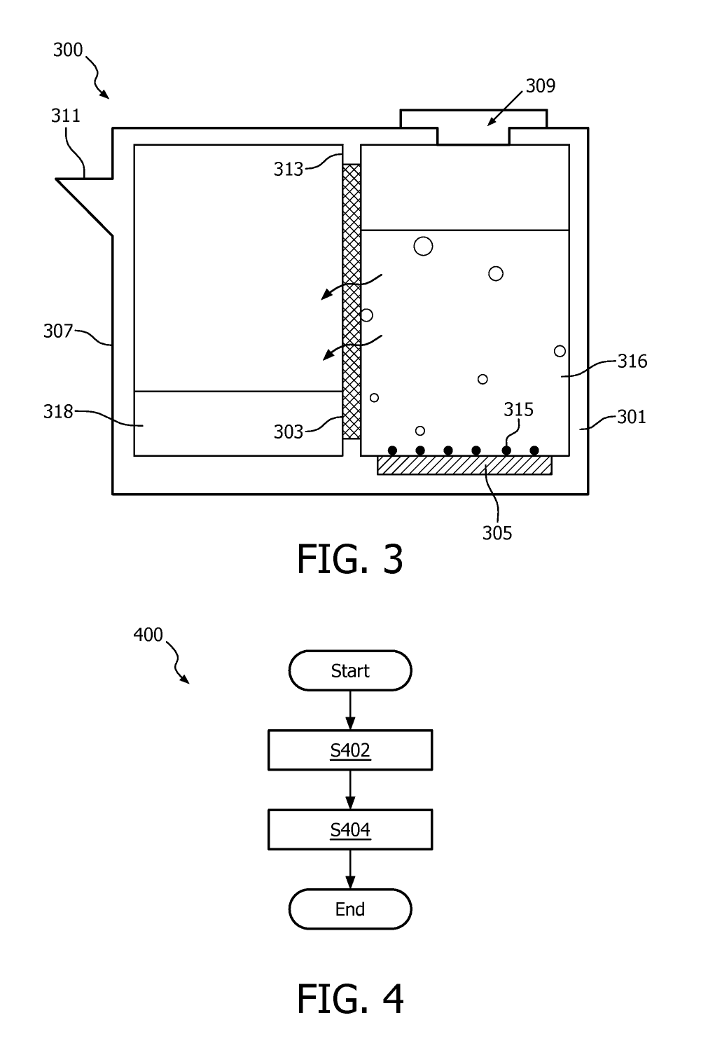

FIG. 3 depicts a kettle 300 according to an embodiment of the invention. As depicted in FIG. 3, the kettle 300 comprises the apparatus 100 in FIG. 1 or the apparatus 200 in FIG. 2. Specifically, the kettle 300 comprises a container 301, a heater 305 and a chamber 307. The container 301 has an opening 309 for the introduction of raw water 316, and the chamber 307 has an outlet 311 for pouring out purified water 318. The container 301 and the chamber 307 are arranged to abut against each other, and a plate 313 is disposed therebetween to separate them from each other. In the embodiment illustrated in FIG. 3, at least a portion of the plate consists of a filter membrane 303.

In operation, when the raw water 316 is heated by the heater 305 disposed below the container 301, the temperature of the raw water 316 increases. The increased temperature causes the raw water 316 to expand, thereby increasing the pressure in the container 301. When the pressure in the container 301 exceeds a pressure threshold, the water 316 in the container 301 will be driven from the container 301 to the chamber 307 through the filter membrane 303, which provides a fluid passage through the container 301. During this process, contaminants 315 in the raw water 316 are kept in the container 301 such that the purified water 318 can be collected in the chamber 307. Therefore, the kettle 300 can provide boiled water 318 of high purity, which is more convenient to use. Moreover, as the heater 305 can heat the raw water 316 in the container 301 to the boil, organic contaminants in the container 301 and/or the filter membrane 303 can be at least partially decomposed at the high temperature. Thus, the apparatus 300 can reduce bio-fouling risks in the filter membrane 303, which further extends the lifetime of the filter membrane 303.

In some embodiments, the filter membrane 303 may be a nano-filtration membrane, such as a ceramic nano-filtration membrane. The ceramic nano-filtration membrane can withstand water temperatures in excess of 100 degrees centigrade . Moreover, the nano-filtration membrane can selectively allow some monovalent ions that do not affect the human body to pass and bar almost all multivalent ions, low-molecular-weight organic substances, organic contaminants such as bacteria, or any other suitable undesirable (?) materials that are too big to pass through the filter membrane 303.

As is clear from the foregoing, the kettle 300 can produce boiled water 318 and additionally perform the water purification process. Thus, no additional heating is needed after the purification. In this way, the kettle 300 can reduce second pollution risk of the boiled water caused by, for example, contamination in a boiler or in a downstream passage.

FIG. 4 depicts a flowchart of a method 400 of purifying liquid according to an embodiment of the invention. The method 400 may be used to purify water, solutions, suspensions or other suitable liquids, by removing solid particles, organic contaminants and metal ions therefrom.

As shown in FIG. 4, the method 400 comprises step S402 of storing liquid in an air-tight container, wherein at least a portion of the container consists of a filter membrane. The method 400 further comprises step S404 of increasing the pressure in the container by heating the liquid such that the liquid is driven out of the container through the filter membrane.

In operation, the air-tight container is heated, for example, by a heater, so as to increase the temperature of the liquid and/or gas in the container. The increased temperature causes the liquid and/or gas in the container to expand, thereby increasing the pressure in the container. After being heated for a period, the pressure in the container may reach or exceed a pressure threshold and then drive the liquid out of the container. In some conditions, the heater may heat the liquid to the boil such that at least a portion of the liquid in the container may be vaporized. The vaporization of the liquid continuously increases the pressure in the container. Thus, the liquid can be continuously driven out of the container through the filter membrane. Moreover, when the liquid passes through the filter membrane, contaminants in the liquid such as solid particles, multivalent ions and organic contaminants are kept in the container by the filter membrane. In this way, the purity of the liquid driven out of the container is improved. Since the filtration is actively driven by heating, the filtration efficiency of the method 400 can be controlled and improved according to various applications.

The filter membrane has filtration pores that permit the liquid to flow out of the container when the pressure in the container exceeds the pressure threshold. In some embodiments, the filter membrane comprises a nano-filtration membrane. The nano-filtration membrane is a pressure-driven membrane, and has pore sizes ranging from 0.1 nm to 10 nm. In an example, the filter membrane may comprise a ceramic nano-filtration membrane. The ceramic nano-filtration membrane can withstand temperatures in excess of 100 degrees centigrade. When the method 400 is used to purify raw water or tap water, the nano-filtration membrane can selectively allow some monovalent ions that do not affect the human body to pass and bar almost all multivalent ions, low-molecular-weight organic substances, organic contaminants such as bacteria, or any other suitable undesirable (?) materials that are too big to pass through the filter membrane.

In some embodiments, the step S404 may further comprise measuring the liquid level in the container and controlling the heating according to the measurement result. The control mechanism can avoid over-heating of the liquid in the container, thereby reducing the safety risks of purifying the liquid. In some other embodiments, the step S404 may further comprise releasing the pressure in the container when the pressure in the container exceeds a predetermined pressure. The predetermined pressure is greater than the pressure threshold, permitting the liquid to flow out of the container. For example, the predetermined pressure relates to the compressive strength of the material and the structure of the container. Therefore, the possibility of damage caused by high pressure in the container can be reduced, which further improves the safety of purifying the liquid.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

1. An apparatus for purifying liquid, comprising:
a container for storing the liquid, wherein at least a portion of the container consists of a filter membrane, the container being air-tight except for a fluid passage provided by filtration pores on the filter membrane; and
a heater for heating the liquid such that the liquid is driven out of the container through the fluid passage;
wherein the filter membrane is disposed above the heater such that at least a portion of bubbles released from the heater during the boiling of the liquid flush along the filter membrane.

2. The apparatus as claimed in claim 1, wherein the filter membrane comprises a nano-filtration membrane.

3. The apparatus as claimed in claim 2, wherein the nano-filtration membrane comprises a ceramic nano-filtration membrane.

4. (canceled)

5. The apparatus as claimed in claim 1, further comprising:
a chamber for collecting the liquid driven out of the container, wherein the chamber is at least partially separated from the container via the filter membrane.

6. The apparatus as claimed in claim 1, further comprising:
a sensor for measuring the liquid level in the container; and
a controller for controlling the heating by the heater according to the measurement from the sensor.

7. The apparatus as claimed in claim 1, further comprising:
a relief valve in fluid communication with the container, configured to maintain the pressure in the container below a predetermined pressure.

8. A kettle comprising the apparatus for purifying liquid as claimed in claim 1.

9. A method of purifying liquid, comprising:
storing liquid in a container, wherein at least a portion of the container consists of a filter membrane; the container being air-tight except for a fluid passage provided by filtration pores on the filter membrane;
increasing the pressure in the container by a heater the liquid such that the liquid is driven out of the container through the filter membrane, the filter membrane being disposed above the heater such that at least a portion of bubbles released from the heater during the boiling of the liquid flush along the filter membrane.

10. The method as claimed in claim 9, wherein the filtration membrane comprises a ceramic nano-filtration membrane.
